(19) United States
(12) Patent Application Publication
(10) Pub. No.: US 2006/0062983 A1
(43) Pub. Date: Mar. 23, 2006

(54) Coatable conductive polyethylenedioxythiophene with carbon nanotubes

(76) Inventors: Glen C. Irvin JR., Rochester, NY (US); Debasis Majumdar, Rochester, NY (US); Charles C. Anderson, Penfield, NY (US); Lawrence A. Rowley, Rochester, NY (US); Gary S. Freedman, Webster, NY (US)

Correspondence Address: Paul A. Leipold;Patent Legal Staff, Eastman Kodak Company, 343 State Street, Rochester, NY, 14650-2201, US

(21) Appl. No.: 10/949,117

(22) Filed: Sep. 17, 2004

(51) Int. Cl. B32B 27/32

(52) U.S. Cl. 428/220

(57) ABSTRACT

The invention relates to a conductive film comprising single wall carbon nanotubes and polyethylenedioxythiophene

### FIELD OF THE INVENTION

The present invention relates to a member comprising a transparent conductive layer comprising single wall carbon nanotubes and polyethylenedioxythiophene/polystyrenesulfonic acid on a substrate and the application of such member in electric devices particularly those suitable for display. In particular, the invention relates to such conductive films having high conductivity and high transparency.

### BACKGROUND OF THE INVENTION

Single wall carbon nanotubes (SWCNTs) are essentially graphene sheets rolled into hollow cylinders thereby resulting in tubules composed of sp² hybridized carbon arranged in hexagons and pentagons, which have outer diameters between 0.4 nm and 10 nm. These SWCNTs are typically capped on each end with a hemispherical fullerene (buckyball) appropriately sized for the diameter of the SWCNT. However, these end caps may be removed via appropriate processing techniques leaving uncapped tubules. SWCNTs can exist as single tubules or in aggregated form typically referred to as ropes or bundles. These ropes or bundles may contain several or a few hundred SWCNTs aggregated through Van der Waals interactions forming triangular lattices where the tube-tube separation is approximately 3-4 Å. Ropes of SWCNTs may be composed of associated bundles of SWCNTs.

The inherent properties of SWCNTs make them attractive for use in many applications. SWCNTs can possess high (e.g. metallic conductivities) electronic conductivities, high thermal conductivities, high modulus and tensile strength, high aspect ratio and other unique properties. Further, SWCNTs may be metallic, semi-metallic, or semiconducting dependant on the geometrical arrangement of the carbon atoms and the physical dimensions of the SWCNT. To specify the size and conformation of single-wall carbon nanotubes, a system has been developed, described below, and is currently utilized. SWCNTs are described by an index (n, m), where n and m are integers that describe how to cut a single strip of hexagonal graphite such that its edges join seamlessly when the strip is wrapped into the form of a cylinder. When n=m e.g. (n,n), the resultant tube is said to be of the “arm-chair” or (n, n) type, since when the tube is cut perpendicularly to the tube axis, only the sides of the hexagons are exposed and their pattern around the periphery of the tube edge resembles the arm and seat of an arm chair repeated n times. When m=0, the resultant tube is said to be of the “zig zag” or (n,0) type, since when the tube is cut perpendicular to the tube axis, the edge is a zig zag pattern. Where n≠m and m≠0, the resulting tube has chirality. The electronic properties are dependent on the conformation, for example, arm-chair tubes are metallic and have extremely high electrical conductivity. Other tube types are semimetals or semi-conductors, depending on their conformation. SWCNTs have extremely high thermal conductivity and tensile strength irrespective of the chirality. The work functions of the metallic (approximately 4.7 eV) and semiconducting (approximately 5.1 eV) types of SWCNTs are different.

Similar to other forms of carbon allotropes (e.g. graphite, diamond) these SWCNTs are intractable and essentially insoluble in most solvents (organic and aqueous alike). Thus, SWCNTs have been extremely difficult to process for various uses. Several methods to make SWCNTs soluble in various solvents have been employed. One approach is to covalently functionalize the ends of the SWCNTs with either hydrophilic or hydrophobic moieties. A second approach is to add high levels of surfactant and/or dispersants (small molecule or polymeric) to help solubilize the SWCNTs.

Lavin et al. in U.S. Pat. No. 6,426,134 disclose a method to form polymer composites using SWCNTs. This method provides a means to melt extrude a SWCNT/polymer composite wherein at least one end of the SWCNT is chemically bonded to the polymer, where the polymer is selected from a linear or branched polyamide, polyester, polyimide, or polyurethane. This method does not provide opportunities for solvent based processing and is limited to melt extrusion which can limit opportunities for patterning or device making. The chemically bonded polymers identified typically have high molecular weights and could interfere with some material properties of the SWCNTs (e.g. electronic or thermal transport) via wrapping around the SWCNTs and preventing tube-tube contacts.

Connell et al in U.S. Patent Application Publication 2003/0158323 A1 describes a method to produce polymer/SWCNT composites that are electrically conductive and transparent. The polymers (polyimides, copolyimides, polyamide acid, polyaryleneether, polymethylmethacrylate) and the SWCNTs or MWCNTs are mixed in organic solvents (DMF, N,N-dimethlacetamide, N-methyl-2-pyrrolidinone, toluene,) to cast films that have conductivities in the range of 10⁻⁵-10⁻¹² S/cm with varying transmissions in the visible spectrum. Additionally, monomers of the resultant polymers may be mixed with SWCNTs in appropriate solvents and polymerized in the presence of these SWCNTs to result in composites with varying weight ratios. The conductivities achieved in these polymer composites are several orders of magnitude too low and not optimal for use in most electronic devices as electronic conductors or EMI shields. Additionally, the organic solvents used are toxic, costly and pose problems in processing. Moreover, the polymers used or polymerized are not conductive and can impede tube-tube contact further increasing the resistivity of the composite.

Kuper et al in Publication WO 03/060941A2 disclose compositions to make suspended carbon nanotubes. The compositions are composed of liquids and SWCNTs or MWCNTs with suitable surfactants (cetyl trimethylammonium bromide/chloride/iodide). The ratio by weight of surfactant to SWCNTs given in the examples range from 1.4-5.2. This method is problematic as it needs extremely large levels of surfactant to solubilize the SWCNTs. The surfactant is insulating and impedes conductivity of a film deposited from this composition. The surfactant may be washed from the film but this step adds complexity and may decrease efficiency in processing. Further, due to the structure formed in films deposited from such a composition, it would be very difficult to remove all the surfactant.

Papadaopoulos et al. in U.S. Pat. No. 5,576,162 describe an imaging element which comprises carbon nanofibers to be used primarily as an anti-static material within the imaging element. These materials may not provide the highly transparent and highly conductive (low SER) layer that is necessary in many current electronic devices, especially displays.

Smalley et al in U.S. Pat. No. 6,645,455 disclose methods to chemically derivatize SWCNTs to facilitate solvation in various solvents. Primarily the various derivative groups (alkyl chains, acyl, thiols, aminos, aryls etc.) are added to the ends of the SWCNTs. The side-walls of the SWCNTs are functionalized primarily with fluorine groups resulting in fluorinated SWCNTs. The solubility limit of such “fluorotubes” in 2-propanol is approximately 0.1 mg/mL and in water or water/acetone mixtures the solubility is essentially zero. The fluorinated SWCNTs were subjected to further chemical reactions to yield methylated SWCNTs and these tubes have a low solubility in Chloroform but not other solvents. Such low concentrations are impractical and unusable for most deposition techniques useful in high quantity manufacturing. Further, such high liquid loads need extra drying considerations and can destroy patterned images due to intermixing from the excess solvent. In addition, the method discloses functionalization of the tubule ends with various functionalization groups (acyl, aryl, aralkyl, halogen, alkyl, amino, halogen, thiol) but the end functionalization alone may not be enough to produce viable dispersions via solubilization. Further, the side-wall functionalization is done with fluorine only, which gives limited solubility in alcohols, which can make manufacturing and product fabrication more difficult. Additionally, the fluorinated SWCNTs are insulators due to the fluorination and thereby are not useful for electronic devices especially as electronic conductors. Moreover, the chemical transformations needed to add these functional groups to the end points of the SWCNTs require additional processing steps and chemicals which can be hazardous and costly.

Smalley et al. in U.S. Pat. No. 6,683,783 disclose methods to purify SWCNT materials resulting in SWCNTs with lengths from 5-500 nm. Within this patent, formulations are disclosed that use 0.5 wt % of a surfactant, Triton X-100 to disperse 0.1 mg/mL of SWCNT in water. Such low concentrations are impractical and unusable for most deposition techniques useful in high quantity manufacturing. Further, such high liquid loads need extra drying considerations and can destroy patterned images due to intermixing from the excess solvent. In addition, the method discloses functionalization of the tubule ends with various functionalization groups (acyl, aryl, aralkyl, halogen, alkyl, amino, halogen, thiol) but the end functionalization alone may not be enough to produce viable dispersions via solubilization. Moreover, the chemical transformations needed to add these functional groups to the end points of the SWCNTs require additional processing steps and chemicals which can be hazardous and costly. Also, the patent discloses a composition of matter which is at least 99% by weight of single wall carbon molecules which obviously limits the amount of functionalization that can be put onto the SWCNTs thereby limiting its solubilization levels and processability.

Rinzler et al. in PCT Publication WO2004/009884 A1 disclose a method of forming SWCNT films on a porous membrane such that it achieves 200 ohms/square and at least 30% transmission at a wavelength of 3 um. This method is disadvantaged since it needs a porous membrane (e.g. polycarbonate or mixed cellulose ester) with a high volume of porosity with a plurality of sub-micron pores as a substrate which may lose a significant amount of the SWCNT dispersion through said pores thereby wasting a significant amount of material. Also, such membranes may not have the optical transparency required for many electronic devices such as displays. Further, the membrane is set within a vacuum filtration system which severely limits the processability of such a system and makes the roll-to-roll coating application of the SWCNT solution impossible. Moreover, the weight percent of the dispersion used to make the SWCNT film was 0.005 mg/mL in an aqueous solution. Such weight percents are impractical and unusable in most coating and deposition systems with such a high liquid load. Such high liquid loads make it virtually impossible to make patterned images due to solvent spreading and therefore image bleeding/destruction.

Blanchet-Fincher et al in Publication WO 02/080195A1 illustrate high conductivity compositions composed of polyaniline (PANI) and SWCNTs or MWCNTs and methods to deposit such compositions from a donor element onto a receiver substrate. The nitrogen base salt derivative of emeraldine polyaniline is mixed with SWCNTs in organic solvents (toluene, xylene, turpinol, aromatics) and cast into films with conductivity values of 62 S/cm (1 wt % SWCNT in PANI) and 44 S/cm (2 wt % SWCNT in PANI). These films alternatively may be produced as part of a multi-layer donor structure suitable as use for a material transfer system. The PANI/SWCNT composite are transferred from the donor sheet to a suitable receiver substrate in imagewise form. PANI is a highly colored conductive polymer thus resulting in a conductive composite with unsatisfactory transparency and color, thus it is not suitable for high transparency/high conductivity applications such as displays. Further, the conductivity values are not suitable for many electronic device applications. In addition, the compositions are made in organic solvents, which may require special handling for health and safety, making manufacturing difficult and expensive.

Hsu in WO 2004/029176 A1 disclose compositions for electronically conducting organic polymer/nanoparticle composites. Polyaniline (Ormecon) or PEDT (Baytron P) are mixed with Molybdenum nanowires or carbon nanotubes (8 nm diameter, 20 um length, 60 S/cm). The compositions disclosed in this invention are disadvantaged by marginal conductivity.

Arthur et al in PCT Publication WO 03/099709 A2 disclose methods for patterning carbon nanotubes coatings. Dilute dispersions (10 to 100 ppm) of SWCNTs in isopropyl alcohol (IPA) and water (which may include viscosity modifying agents) are spray coated onto substrates. After application of the SWCNT coating, a binder is printed in imagewise fashion and cured. Alternatively, a photo-definable binder may be used to create the image using standard photolithographic processes. Materials not held to the substrate with binder are removed by washing. Dilute dispersions (10 to 100 ppm) of SWCNTs in isopropyl alcohol (IPA) and water with viscosity modifying agents are gravure coated onto substrates. Dilute dispersions (10 to 100 ppm) of SWCNTs in isopropyl alcohol (IPA) and water are spray coated onto substrates. The coated films are then exposed through a mask to a high intensity light source in order to significantly alter the electronic properties of the SWCNTs. This step is followed by a binder coating. The dispersion concentrations used in these methods make it very difficult to produce images via direct deposition (inkjet etc.) techniques. Further, such high solvent loads due to the low solids dispersions create long process times and difficulties handling the excess solvent. In addition, these patterning methods are subtractive processes, which unnecessarily waste the SWCNT material via additional removal steps thereby incurring cost and process time. This application also discloses method to make conductive compositions and coatings from such compositions but it does not teach satisfactory methods nor compositions to execute such methods.

Transparent electrically-conductive layers (TCL) of metal oxides such as indium tin oxide (ITO), antimony doped tin oxide, and cadmium stannate (cadmium tin oxide) are commonly used in the manufacture of electrooptical display devices such as liquid crystal display devices (LCDs), electroluminescent display devices, photocells, solid-state image sensors and electrochromic windows or as components of these devices such as electromagnetic interference (EMI) shielding.

Devices such as flat panel displays, typically contain a substrate provided with an indium tin oxide (ITO) layer as a transparent electrode. The coating of ITO is carried out by vacuum sputtering methods which involve high substrate temperature conditions up to 250° C., and therefore, glass substrates are generally used. The high cost of the fabrication methods and the low flexibility of such electrodes, due to the brittleness of the inorganic ITO layer as well as the glass substrate, limit the range of potential applications. As a result, there is a growing interest in making all-organic devices, comprising plastic resins as a flexible substrate and organic electroconductive polymer layers as an electrode. Such plastic electronics allow low cost devices with new properties. Flexible plastic substrates can be provided with an electroconductive polymer layer by continuous hopper or roller coating methods (compared to batch process such as sputtering) and the resulting organic electrodes enable the “roll to roll” fabrication of electronic devices which are more flexible, lower cost, and lower weight.

Intrinsically conductive polymers have recently received attention from various industries because of their electronic conductivity. Although many of these polymers are highly colored and are less suited for TCL applications, some of these intrinsically conductive polymers, such as substituted or unsubstituted pyrrole-containing polymers (as mentioned in U.S. Pat. Nos. 5,665,498 and 5,674,654), substituted or unsubstituted thiophene-containing polymers (as mentioned in U.S. Pat. Nos. 5,300,575, 5,312,681, 5,354,613, 5,370,981, 5,372,924, 5,391,472, 5,403,467, 5,443,944, 5,575,898, 4,987,042, and 4,731,408) and substituted or unsubstituted aniline-containing polymers (as mentioned in U.S. Pat. Nos. 5,716,550, 5,093,439, and 4,070,189) are transparent and not prohibitively colored, at least when coated in thin layers at moderate coverage. Because of their electronic conductivity instead of ionic conductivity, these polymers are conducting even at low humidity.

EP-A-440 957 describes a method for preparing polythiophene in an aqueous mixture by oxidative polymerization in the presence of a polyanion as a doping agent. In EP-A-686 662 it has been disclosed that highly conductive layers of polythiophene, coated from an aqueous coating solution, could be made by the addition of a di- or polyhydroxy and/or a carbonic acid, amide or lactam group containing compound in the coating solution of the polythiophene. Coated layers of organic electroconductive polymers can be patterned into electrode arrays using different methods. The known wet-etching microlithography technique is described in WO97/18944 and U.S. Pat. No. 5,976,274 wherein a positive or negative photoresist is applied on top of a coated layer of an organic electroconductive polymer, and after the steps of selectively exposing the photoresist to UV light, developing the photoresist, etching the electroconductive polymer layer and finally stripping the non-developed photoresist, a patterned layer is obtained. In U.S. Pat. No. 5,561,030 a similar method is used to form the pattern except that the pattern is formed in a continuous layer of prepolymer which is not yet conductive and that after washing the mask away the remaining prepolymer is rendered conductive by oxidation. Such methods that involve conventional lithographic techniques are cumbersome as they involve many steps and require the use of hazardous chemicals.

EP-A-615 256 describes a method to produce a pattern of a conductive polymer on a substrate that involves coating and drying a composition containing 3,4-ethylenedioxythiophene monomer, an oxidation agent, and a base; exposing the dried layer to UV radiation through a mask; and then heating. The UV exposed areas of the coating comprise non-conductive polymer and the unexposed areas comprise conductive polymer. The formation of a conductive polymer pattern in accordance with this method does not require the coating and patterning of a separate photoresist layer.

U.S. Pat. No. 6,045,977 describes a process for patterning conductive polyaniline layers containing a photobase generator. UV exposure of such layers produces a base that reduces the conductivity in the exposed areas.

EP-A-1 054 414 describes a method to pattern a conductive polymer layer by printing an electrode pattern onto said conductive polymer layer using a printing solution containing an oxidant selected from the group ClO⁻, BrO⁻, MnO₄⁻, Cr₂O₇⁻², S₂O₈⁻², and H₂O₂. The areas of the conductive layer exposed to the oxidant solution are rendered nonconductive.

Research Disclosure, November 1998, page 1473 (disclosure no. 41548) describes various means to form patterns in conducting polymer, including photoablation wherein the selected areas are removed from the substrate by laser irradiation. Such photoablation processes are convenient, dry, one-step methods but the generation of debris may require a wet cleaning step and may contaminate the optics and mechanics of the laser device. Prior art methods involving removal of the electroconductive polymer to form the electrode pattern also induce a difference of the optical density between electroconductive and non-conductive areas of the patterned surface, which should be avoided.

Methods of patterning organic electroconductive polymer layers by image-wise heating by means of a laser have been disclosed in EP 1 079 397 A1. That method induces about a 10 to 1000 fold decrease in resistivity without substantially ablating or destroying the layer.

The application of electronically conductive polymers in display related device has been envisioned in the past. The application of electronically conductive polymers in display related devices has been envisioned in the past. European Patent Application EP9910201 describes a light transmissive substrate having a light transmissive conductive polymer coating for use in resistive touch screens. U.S. Pat. No. 5,738,934 describes touch screen cover sheets having a conductive polymer coating.

U.S. Pat. Nos. 5,828,432 and 5,976,284 describe conductive polymer layers employed in liquid crystal display devices. The example conductive layers are highly conductive but typically have transparency of 60% or less.

Use of polythiophene as transparent field spreading layers in displays comprising polymer dispersed liquid crystals has been disclosed in U.S. Pat. Nos. 6,639,637 and 6,707,517. However, the polythiophene layers in these patents are non-conductive in nature.

Use of commercial polythiophene coated sheet such as Orgacon from Agfa has been suggested for manufacturing of thin film inorganic light emitting diode has been suggested in U.S. Pat. No. 6,737,293. However, as discussed later, the transparency vs. surface electrical resistivity of such products may not be sufficient for some applications.

Use of conductive high molecular film for preventing the fringe field in the in-plane switching mode in liquid crystal display has been proposed in U.S. Pat. No. 5,959,708. However, the conductivity requirement for these films appears to be not very stringent. For example, in one embodiment (col. 5, lines 6-10) the high molecular film can be totally non-conductive. Moreover, U.S. Pat. No. 5,959,708 does not refer to any specification involving transmission characteristics of these films.

Use of transparent coating on glass substrates for cathode ray tubes using polythiophene and silicon oxide composites has been disclosed in U.S. Pat. No. 6,404,120. However, the method suggests in-situ polymerization of an ethylenedioxythiohene monomer on glass, baking it at an elevated temperature and subsequent washing with tetra ethyl orthosilicate. Such an involved process may be difficult to practice for roll-to-roll production of a wide flexible plastic substrate.

Use of in-situ polymerized polythiophene and polypyrrole has been proposed in U.S. Pat Appl. Pub. 2003/0008135 A1 as conductive films, for ITO replacement. As mentioned earlier, such processes are difficult to implement for roll-to-roll production of conductive coatings. In the same patent application, a comparative example was created using a dispersion of poly (3,4 ethylene dioxythiophene)/polystyrene sulfonic acid which resulted in inferior coating properties.

Addition of conductivity enhancing agents such as organic compounds with dihydroxy or polyhydroxy and/or carboxyl groups or amide groups or lactam groups are suggested for incorporation in polythiophene in U.S. Pat. No. 5,766,515. Recently, U.S. Pat. Appl. Pub. 2003/0193042 A1 claims further improvement in conductivity of polythiophene through the addition of a substantial quantity of organic compounds such as phenols. But, health and safety concerns will dictate special precautionary measures, which may need to be taken, for the introduction of such hazardous compounds to a typical web manufacturing and coating site, thus possibly adding cost to the final product.

In another recent publication titled “Hydroxylated secondary dopants for surface resistance enhancement in transparent poly(3,4-ethylenedioxythiophene)-poly(styrenesulfonate) thin films” by B. D. Martin, N. Nikolov, S. K. Pollack, A. Saprigin, R. Shashidhar, F. Zhang and P. A. Heiney, published in Synthetic Metals, vol. 142 (2004), p. 187-193, it was stated that the addition of small hydroxylated secondary dopants could greatly decrease the surface resistance of polythiophene films without reducing film transparency. However, as will be demonstrated later, the surface electrical resistance and transparency of the films quoted in this paper are not at par with the present invention.

As indicated herein above, the art discloses a wide variety of electrically conductive TCL compositions that can be incorporated in displays. Although application of electronically conductive polymers in display related devices has been contemplated in the past, the stringent requirement of high transparency and low surface electrical resistivity demanded by modern display devices is extremely difficult to attain with intrinsically conductive polymers. Thus, there is still a critical need in the art for intrinsically conductive polymers that can be coated roll-to-roll on a wide variety of substrates under typical manufacturing conditions using environmentally desirable components. In addition to providing superior electrode performance, the TCL layers also must be highly transparent, must be patternable, must resist the effects of humidity change, and be manufacturable at a reasonable cost.

As indicated herein above, the art discloses a wide variety of electrically conductive TCL compositions. However, there is still a critical need in the art for patterned conductive TCL structures. In addition to providing superior electrode performance, the TCL layers also must be highly transparent, must be patternable, must resist the effects of humidity change, and be manufacturable at a reasonable cost.

### PROBLEM TO BE SOLVED BY THE INVENTION

There is a need to provide improved electronically conductive, patternable, preferably coatable, conductive films that more effectively meet the diverse commercial needs than those of the prior art that the present invention is directed.

### SUMMARY OF THE INVENTION

It is another object to provide electronically conductive films with high transparency and high conductivity.

It is a further object to reduce contact resistances between oligomers of PEDOT and/or tubes or bundles of SWCNTs.

It is still further an object to provide an improved process of forming a conductive film comprising SWCNTs.

These and other objects of the invention are accomplished by a conductive film comprising single wall carbon nanotubes and PEDOT

### BRIEF DESCRIPTION OF THE DRAWINGS

FIG. 1. A schematic of pristine single wall carbon nanotubes with closed ends of the tubules.

FIG. 2. A schematic of pristine single wall carbon nanotubes with open ends of the tubules.

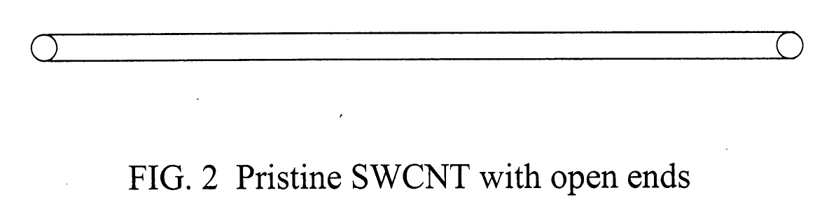

FIG. 3. A schematic of a display component comprising a substrate, and an electronically conductive layer connected to a power source by an electric lead, as per the invention.

FIG. 4. A schematic of an illustrative polymer dispersed LC display, as per the invention.

FIG. 5. A schematic of an OLED based display, as per the invention.

FIG. 6. A schematic of an illustrative resistive-type touch screen, as per the invention.

### DETAILED DESCRIPTION OF THE INVENTION

The invention has numerous advantages. The invention provides a facile method to improve the conductivity of the conductive polymer by adding highly conductive SWCNTs. The invention provides a method to have a highly conductive and transparent infrared absorber. The invention provides a ready method to provide conductive film forming capabilities.

These and other advantages will be apparent from the detailed description below.

The transparent conductive layer of the invention comprises single wall carbon nanotubes and an electronically conductive polymer of a polythiophene present in a cationic form with a polyanion or anion.

The SWCNTs may be formed by any known methods in the art (laser ablation, CVD, arc discharge). The SWCNTs are preferred to have minimal or no impurities of metals that may be used in such synthetic methods and carbonaceous impurities that are not single wall carbon nanotubes (graphite, amorphous, diamond, non-tubular fullerenes, multiwall carbon nanotubes). It is found that the transparency increases significantly with the decrease of metallic and carbonaceous impurities. The film quality also improves.

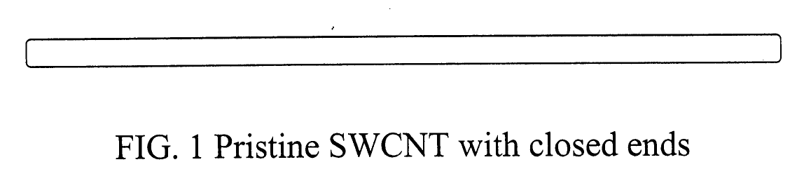

Metallic SWCNTs are the most preferred type but semimetallic and semiconducting SWCNTs may also be used. Pristine SWCNTs are also preferred where pristine means that the surface of the SWCNT is free of functionalized materials either through synthetic prep, acid cleanup of impurities, or directed functionalization. Some applications may require other types of functionalization such as polymer, small molecule or combinations thereof. Embodiments of preferred SWCNTs (pristine) are illustrated in FIG. 1.

The length of the SWCNTs may be from 20 nm-1 m. The SWCNTs may exist as individual SWCNTs or as bundles of SWCNTs. The diameter of a SWCNT in the conductive layer may be 0.5 nm-5 nm. The SWCNTs in bundled form may have diameters ranging from 1 nm-1 um. Preferably such bundles will have diameters less than 50 nm and preferably less than 20 nm. The ends of the SWCNTs may be closed by a hemispherical buckyball of appropriate size. Alternatively, the ends of the SWCNTs may be open. Some cases may find one end open and the other closed.

Electronically conductive polymers may be soluble or dispersible in organic solvents or water or mixtures thereof. The conductive poly(3,4-ethylenedioxythiophene (PEDOT) may be supplied by either of two routes. First, it may be synthesized via an in-situ oxidative polymerization where the monomer, ethylenedioxythiophene (EDOT), is dissolved within a suitable solvent (e.g. butanol). There are a number of oxidizing agents that may be used including ammonium persulfate, and iron(III) salts of organic and inorganic acids. Second, an aqueous dispersion of a cationic PEDOT mixed with a polyanion, such as polystyrenesulfonic acid, may be used. For environmental reasons, aqueous compositions are preferred.

A preferred electronically conductive polymer comprises 3,4-dialkoxy substituted polythiophene styrene sulfonate because of its relatively neutral color. The most preferred electronically conductive polymers include poly(3,4-ethylene dioxythiophene styrene sulfonate) which comprises poly(3,4-ethylene dioxythiophene) in a cationic form with polystyrenesulfonic acid. The advantage of choosing the aforementioned polymers arise from the fact that they are primarily water based, stable polymer structure to light and heat, stable dispersions and cause minimum concern for storage, health, environmental and handling.

Preparation of the aforementioned polythiophene based polymers has been discussed in detail in a publication titled “Poly(3,4-ethylenedioxythiophene) and its derivatives: past, present and future” by L. B. Groenendaal, F. Jonas, D. Freitag, H. Pielartzik and J. R. Reynolds in Advanced Materials, (2000), 12, No. 7, pp. 481-494, and references therein.

The conductive layer of the invention should contain about 0.1 to about 1000 mg/m² dry coating weight of the electronically conductive polymer. Preferably, the conductive layer should contain about 1 to about 500 mg/m² dry coating weight of the electronically conductive polymer. The actual dry coating weight of the conductive polymer applied is determined by the properties of the particular conductive polymer employed and by the requirements of the particular application. These requirements include conductivity, transparency, optical density and cost for the layer.

In a preferred embodiment, the layer containing the electronically conductive polymer is prepared by applying a mixture comprising:

a) a polythiophene according to Formula I 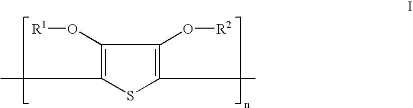
in a cationic form, wherein each of R₁ and R₂ independently represents hydrogen or a C1-4 alkyl group or together represent an optionally substituted C1-4 alkylene group or a cycloalkylene group, preferably an ethylene group, an optionally alkyl-substituted methylene group, an optionally C1-12 alkyl- or phenyl-substituted 1,2-ethylene group, a 1,3-propylene group or a 1,2-cyclohexylene group; and n is 3 to 1000; and

b) a polyanion compound;
It is preferred that the electronically conductive polymer and polyanion combination is soluble or dispersible in organic solvents or water or mixtures thereof. For environmental reasons, aqueous systems are preferred. Polyanions used with these electronically conductive polymers include the anions of polymeric carboxylic acids such as polyacrylic acids, poly(methacrylic acid), and poly(maleic acid), and polymeric sulfonic acids such as polystyrenesulfonic acids and polyvinylsulfonic acids, the polymeric sulfonic acids being preferred for use in this invention because they are widely available and water coatable. These polycarboxylic and polysulfonic acids may also be copolymers formed from vinylcarboxylic and vinylsulfonic acid monomers copolymerized with other polymerizable monomers such as the esters of acrylic acid and styrene. The molecular weight of the polyacids providing the polyanions preferably is 1,000 to 2,000,000 and more preferably 2,000 to 500,000. The polyacids or their alkali salts are commonly available, for example as polystyrenesulfonic acids and polyacrylic acids, or they may be produced using known methods. Instead of the free acids required for the formation of the electrically conducting polymers and polyanions, mixtures of alkali salts of polyacids and appropriate amounts of monoacids may also be used. The polythiophene to polyanion weight ratio can widely vary between 1:99 to 99:1, however, optimum properties such as high electrical conductivity and dispersion stability and coatability are obtained between 85:15 and 15:85, and more preferably between 50:50 and 15:85. The most preferred electronically conductive polymers include poly(3,4-ethylene dioxythiophene styrene sulfonate) which comprises poly(3,4-ethylene dioxythiophene) in a cationic form and polystyrenesulfonic acid because of its low optical density, stability, wide availability, high conductivity and ability to be coated from water.

Desirable results such as enhanced conductivity of the PEDOT/polystyrenesulfonic acid can be accomplished by incorporating a conductivity enhancing agent (CEA). Preferred CEAs are organic compounds containing dihydroxy, poly-hydroxy, carboxyl, amide, or lactam groups, such as

(1) those represented by the following Formula II:
(OH)ₙ—R—(COX)ₘ II

wherein m and n are independently an integer of from 1 to 20, R is an alkylene group having 2 to 20 carbon atoms, an arylene group having 6 to 14 carbon atoms in the arylene chain, a pyran group, or a furan group, and X is —OH or —NYZ, wherein Y and Z are independently hydrogen or an alkyl group; or

(2) a sugar, sugar derivative, polyalkylene glycol, or glycerol compound; or

(3) those selected from the group consisting of N-methylpyrrolidone, pyrrolidone, caprolactam, N-methyl caprolactam, dimethyl sulfoxide or N-octylpyrrolidone; or

(4) a combination of the above.

Particularly preferred conductivity enhancing agents are: sugar and sugar derivatives such as sucrose, glucose, fructose, lactose; sugar alcohols such as sorbitol, mannitol; furan derivatives such as 2-furancarboxylic acid, 3-furancarboxylic acid and alcohols. Ethylene glycol, glycerol, di- or triethylene glycol are most preferred because they provide the maximum conductivity enhancement.

The CEA can be incorporated by any suitable method. Preferably the CEA is added to the coating composition comprising the SWCNTs and polythiophene. Alternatively, the coated SWCNT/polythiophene containing layer can be exposed to the CEA by any suitable method, such as post-coating wash.

The concentration of the CEA in the coating composition may vary widely depending on the particular organic compound used and the conductivity requirements. However, convenient concentrations that may be effectively employed in the practice of the present invention are about 0.5 to about 25 weight %; more conveniently 0.5 to 10 and more desirably 0.5 to 5 as it provides the minimum effective amount.

While the electronically conductive polymer can be applied without the addition of a film-forming polymeric binder, a film-forming binder can be employed to improve the physical properties of the layer. In such an embodiment, the layer may comprise from about 1 to 95% of the film-forming polymeric binder. However, the presence of the film forming binder may increase the overall surface electrical resistivity of the layer. The optimum weight percent of the film-forming polymer binder varies depending on the electrical properties of the electronically conductive polymer, the chemical composition of the polymeric binder, and the requirements for the particular circuit application.

Polymeric film-forming binders useful in the conductive layer of this invention can include, but are not limited to, water-soluble or water-dispersible hydrophilic polymers such as gelatin, gelatin derivatives, maleic acid or maleic anhydride copolymers, polystyrene sulfonates, cellulose derivatives (such as carboxymethyl cellulose, hydroxyethyl cellulose, cellulose acetate butyrate, diacetyl cellulose, and triacetyl cellulose), polyethylene oxide, polyvinyl alcohol, and poly-N-vinylpyrrolidone. Other suitable binders include aqueous emulsions of addition-type homopolymers and copolymers prepared from ethylenically unsaturated monomers such as acrylates including acrylic acid, methacrylates including methacrylic acid, acrylamides and methacrylamides, itaconic acid and its half-esters and diesters, styrenes including substituted styrenes, acrylonitrile and methacrylonitrile, vinyl acetates, vinyl ethers, vinyl and vinylidene halides, and olefins and aqueous dispersions of polyurethanes and polyesterionomers.

Other ingredients that may be included in the layer containing the electronically conductive polymer include but are not limited to surfactants, defoamers or coating aids, charge control agents, thickeners or viscosity modifiers, antiblocking agents, coalescing aids, crosslinking agents or hardeners, soluble and/or solid particle dyes, matte beads, inorganic or polymeric particles, adhesion promoting agents, bite solvents or chemical etchants, lubricants, plasticizers, antioxidants, colorants or tints, and other addenda that are well-known in the art. Preferred bite solvents can include any of the volatile aromatic compounds disclosed in U.S. Pat. No. 5,709,984, as “conductivity-increasing” aromatic compounds, comprising an aromatic ring substituted with at least one hydroxy group or a hydroxy substituted substituents group. These compounds include phenol, 4-chloro-3-methyl phenol, 4-chlorophenol, 2-cyanophenol, 2,6-dichlorophenol, 2-ethylphenol, resorcinol, benzyl alcohol, 3-phenyl-1-propanol, 4-methoxyphenol, 1,2-catechol, 2,4-dihydroxytoluene, 4-chloro-2-methyl phenol, 2,4-dinitrophenol, 4-chlororesorcinol, 1-naphthol, 1,3-naphthalenediol and the like. These bite solvents are particularly suitable for polyester based polymer sheets of the invention. Of this group, the most preferred compounds are resorcinol and 4-chloro-3-methyl phenol. Preferred surfactants suitable for these coatings include nonionic and anionic surfactants. Preferred cross-linking agents suitable for these coatings include silane compounds such as those disclosed in U.S. Pat. No. 5,370,981.

A figure of merit (FOM) can be assigned to the electronically conductive polymer within the conductive layer. Such FOM values are determined by (1) measuring the visual light transmission (T) and the surface electrical resistance (SER) of the conductive layer at various thickness values of the layer, (2) plotting these data in a in (1/T) vs. 1/SER space, and (3) then determining the slope of a straight line best fitting these data points and passing through the origin of such a plot. Without being bound to any particular theory, it is found that in (1/T) vs. 1/SER plots for electronically conductive polymer layers, particularly those comprising polythiophene in a cationic form with a polyanion compound, generate a linear relationship, preferably one passing through the origin, wherein the slope of such a linear plot is the FOM of the electronically conductive polymer layer. Without being bound to any particular theory, it is also found that lower the FOM value, more desirable is the electrical and optical characteristics of the electronically conductive layer; namely, lower the FOM, lower is the SER and higher is the transparency of the conductive layer. For the instant invention, FOM values of <100, preferably ≦50, and more preferably ≦40 is found to generate most desired results for display applications,

Visual light transmission value T is determined from the total optical density at 530 nm, after correcting for the contributions of the uncoated substrate. A Model 361T X-Rite densitometer measuring total optical density at 530 nm, is best suited for this measurement.

Visual light transmission, T, is related to the corrected total optical density at 530 nm, o.d.(corrected), by the following expression,
T=1/(10^{o.d.(corrected)})

The SER value is typically determined by a standard four-point electrical probe.

The SER value of the conductive layer of the invention can vary according to need. For use as an electrode in a display device, the SER is typically less than 10000 ohms/square, preferably less than 5000 ohms/square, and more preferably less than 1000 ohms/square and most preferably less than 500 ohms/square, as per the current invention.

The transparency of the conductive layer of the invention can vary according to need. For use as an electrode in a display device, the conductive layer is desired to be highly transparent. Accordingly, the visual light transmission value T for the conductive layer of the invention is >65%, preferably ≧70%, more preferably ≧80%, and most preferably ≧90%. The conductive layer need not form an integral whole, need not have a uniform thickness and need not be contiguous with the base substrate.

The conductive layer can be prepared by numerous methods. A preferred embodiment of the invention is to prepare the conductive layer by first forming a mixture of the SWCNTs and PEDOT/PSS in dispersion. This material can be coated on a substrate by any number of ways as outlined below. SWCNTs of metallic type are also preferred. Mixtures of metallic, semiconducting, and semimetallic SWCNTs are sufficient. The pH of the mixture may be within a range of 1-12. Preferably, the pH of the mixture will be within a range of 1-7. The mixture may employ a CEA to further improve the conductivity of the PEDOT/PSS. Coating aids may be added to improve coating quality. Additionally, surfactants may be employed to improve the dispersability of the SWCNTs in the mixture.

In another preferred embodiment, the SWCNTs and EDOT monomer with oxidative catalyst can be made to form a mixture in a suitable solvent. This mixture can be deposited onto a substrate and then polymerize the EDOT monomer. After the polymerization, it is necessary to remove the residual catalyst by washing with water or a suitable alcohol. The resultant film provides a highly conductive layer.

In another preferred embodiment, the SWCNTs may be coated and dried on the substrate first and then a predetermined amount of PEDOT may be coated onto the SWCNT film. The PEDOT may be supplied either as PEDOT/PSS or as the EDOT monomer/catalyst solution, which can be polymerized after coating onto the SWCNT film. In the case of the EDOT in-situ polymerization, another step of washing the residual catalyst salts out is necessary by washing with water or a suitable alcohol.

In another preferred embodiment, the PEDOT may be first coated onto a substrate. The PEDOT may be supplied either as PEDOT/PSS or as the EDOT monomer/catalyst solution, which can be polymerized after coating onto the SWCNT film. In the case of the EDOT in-situ polymerization, another step of washing the residual catalyst salts out is necessary by washing with water or a suitable alcohol. Then, a predetermined amount of SWCNT may be applied onto the PEDOT film to form the conductive layer.

The conductive layer of the invention can be formed on any rigid or flexible substrate. The substrates can be transparent, translucent or opaque, and may be colored or colorless. Rigid substrates can include glass, metal, ceramic and/or semiconductors. Flexible substrates, especially those comprising a plastic substrate, are preferred for their versatility and ease of manufacturing, coating and finishing.

The flexible plastic substrate can be any flexible self substrateing plastic film that substrates the conductive polymeric film. “Plastic” means a high polymer, usually made from polymeric synthetic resins, which may be combined with other ingredients, such as curatives, fillers, reinforcing agents, colorants, and plasticizers. Plastic includes thermoplastic materials and thermosetting materials.

The flexible plastic film must have sufficient thickness and mechanical integrity so as to be self-substrateing, yet should not be so thick as to be rigid. Another significant characteristic of the flexible plastic substrate material is its glass transition temperature (Tg). Tg is defined as the glass transition temperature at which plastic material will change from the glassy state to the rubbery state. It may comprise a range before the material may actually flow. Suitable materials for the flexible plastic substrate include thermoplastics of a relatively low glass transition temperature, for example up to 150° C., as well as materials of a higher glass transition temperature, for example, above 150° C. The choice of material for the flexible plastic substrate would depend on factors such as manufacturing process conditions, such as deposition temperature, and annealing temperature, as well as post-manufacturing conditions such as in a process line of a displays manufacturer. Certain of the plastic substrates discussed below can withstand higher processing temperatures of up to at least about 200° C., some up to 300°-350° C., without damage.

Typically, the flexible plastic substrate is a polyester including polyethylene terephthalate (PET), polyethylene naphthalate (PEN), polyester ionomer, polyethersulfone (PES), polycarbonate (PC), polysulfone, a phenolic resin, an epoxy resin, polyester, polyimide, polyetherester, polyetheramide, cellulose nitrate, cellulose acetate, poly(vinyl acetate), polystyrene, polyolefins including polyolefin ionomers, polyamide, aliphatic polyurethanes, polyacrylonitrile, polytetrafluoroethylenes, polyvinylidene fluorides, poly(methyl (x-methacrylates), an aliphatic or cyclic polyolefin, polyarylate (PAR), polyetherimide (PEI), polyethersulphone (PES), polyimide (PI), Teflon poly(perfluoro-alboxy) fluoropolymer (PFA), poly(ether ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA) natural and synthetic paper, resin-coated or laminated paper, voided polymers including polymeric foam, microvoided polymers and microporous materials, or fabric, or any combinations thereof.

Aliphatic polyolefins may include high density polyethylene (HDPE), low density polyethylene (LDPE), and polypropylene, including oriented polypropylene (OPP). Cyclic polyolefins may include poly(bis(cyclopentadiene)). A preferred flexible plastic substrate is a cyclic polyolefin or a polyester. Various cyclic polyolefins are suitable for the flexible plastic substrate. Examples include Arton® made by Japan Synthetic Rubber Co., Tokyo, Japan; Zeanor T made by Zeon Chemicals L. P., Tokyo Japan; and Topas® made by Celanese A. G., Kronberg Germany. Arton is a poly(bis(cyclopentadiene)) condensate that is a film of a polymer. Alternatively, the flexible plastic substrate can be a polyester. A preferred polyester is an aromatic polyester such as Arylite. Although the substrate can be transparent, translucent or opaque, for most display applications transparent members comprising transparent substrate(s) are preferred. Although various examples of plastic substrates are set forth above, it should be appreciated that the flexible substrate can also be formed from other materials such as flexible glass and ceramic.

The flexible plastic substrate can be reinforced with a hard coating. Typically, the hard coating is an acrylic coating. Such a hard coating typically has a thickness of from 1 to 15 microns, preferably from 2 to 4 microns and can be provided by free radical polymerization, initiated either thermally or by ultraviolet radiation, of an appropriate polymerizable material. Depending on the substrate, different hard coatings can be used. When the substrate is polyester or Arton, a particularly preferred hard coating is the coating known as “Lintec.” Lintec contains UV cured polyester acrylate and colloidal silica. When deposited on Arton, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wis.

The most preferred flexible plastic substrate is a polyester because of its superior mechanical and thermal properties as well as its availability in large quantity at a moderate price. The particular polyester chosen for use can be a homo-polyester or a co-polyester, or mixtures thereof as desired. The polyester can be crystalline or amorphous or mixtures thereof as desired. Polyesters are normally prepared by the condensation of an organic dicarboxylic acid and an organic diol and, therefore, illustrative examples of useful polyesters will be described herein below in terms of these diol and dicarboxylic acid precursors.

Polyesters which are suitable for use in this invention are those which are derived from the condensation of aromatic, cycloaliphatic, and aliphatic diols with aliphatic, aromatic and cycloaliphatic dicarboxylic acids and may be cycloaliphatic, aliphatic or aromatic polyesters. Exemplary of useful cycloaliphatic, aliphatic and aromatic polyesters which can be utilized in the practice of their invention are poly(ethylene terephthalate), poly(cyclohexlenedimethylene), terephthalate) poly(ethylene dodecate), poly(butylene terephthalate), poly(ethylene naphthalate), poly(ethylene(2,7-naphthalate)), poly(methaphenylene isophthalate), poly(glycolic acid), poly(ethylene succinate), poly(ethylene adipate), poly(ethylene sebacate), poly(decamethylene azelate), poly(ethylene sebacate), poly(decamethylene adipate), poly(decamethylene sebacate), poly(dimethylpropiolactone), poly(para-hydroxybenzoate) (Ekonol), poly(ethylene oxybenzoate) (A-tell), poly(ethylene isophthalate), poly(tetramethylene terephthalate, poly(hexamethylene terephthalate), poly(decamethylene terephthalate), poly(1,4-cyclohexane dimethylene terephthalate) (trans), poly(ethylene 1,5-naphthalate), poly(ethylene 2,6-naphthalate), poly(1,4-cyclohexylene dimethylene terephthalate), (Kodel) (cis), and poly(1,4-cyclohexylene dimethylene terephthalate (Kodel) (trans). Polyester compounds prepared from the condensation of a diol and an aromatic dicarboxylic acid is preferred for use in this invention. Illustrative of such useful aromatic carboxylic acids are terephthalic acid, isophthalic acid and an α-phthalic acid, 1,3-napthalenedicarboxylic acid, 1,4 napthalenedicarboxylic acid, 2,6-napthalenedicarboxylic acid, 2,7-napthalenedicarboxylic acid, 4,4′-diphenyldicarboxylic acid, 4,4′-diphenysulfphone-dicarboxylic acid, 1,1,3-trimethyl-5-carboxy-3-(p-carboxyphenyl)-idane, diphenyl ether 4,4′-dicarboxylic acid, bis-p(carboxy-phenyl) methane, and the like. Of the aforementioned aromatic dicarboxylic acids, those based on a benzene ring (such as terephthalic acid, isophthalic acid, orthophthalic acid) are preferred for use in the practice of this invention. Amongst these preferred acid precursors, terephthalic acid is particularly preferred acid precursor.

Preferred polyesters for use in the practice of this invention include poly(ethylene terephthalate), poly(butylene terephthalate), poly(1,4-cyclohexylene dimethylene terephthalate) and poly(ethylene naphthalate) and copolymers and/or mixtures thereof. Among these polyesters of choice, poly(ethylene terephthalate) is most preferred because of its low cost, high transparency, and low coefficient of thermal expansion.

The aforesaid substrate useful for application in display devices can be planar and/or curved. The curvature of the substrate can be characterized by a radius of curvature, which may have any value. Alternatively, the substrate may be bent so as to form an angle. This angle may be any angle from 0° to 360°, including all angles therebetween and all ranges therebetween. If the substrate is electrically conducting, an insulating material such as a non-conductive polymer may be placed between the substrate and the conducting polymer.

The substrate may be of any thickness, such as, for example. 10⁻⁸ cm to 1 cm including all values in between and all ranges therebetween. Thicker and thinner layers may be used. The substrate need not have a uniform thickness. The preferred shape is square or rectangular, although any shape may be used. Before the substrate is coated with the conducting polymer it may be physically and/or optically patterned, for example by rubbing, by the application of an image, by the application of patterned electrical contact areas, by the presence of one or more colors in distinct regions, by embossing, microembossing, microreplication, etc.

The aforesaid substrate can comprise a single layer or multiple layers according to need. The multiplicity of layers may include any number of auxiliary layers such as antistatic layers, tie layers or adhesion promoting layers, abrasion resistant layers, curl control layers, conveyance layers, barrier layers, splice providing layers, UV absorption layers, optical effect providing layers, such as antireflective and antiglare layers, waterproofing layers, adhesive layers, imaging layers and the like.

The polymer substrate can be formed by any method known in the art such as those involving extrusion, coextrusion, quenching, orientation, heat setting, lamination, coating and solvent casting. It is preferred that the polymer substrate is an oriented sheet formed by any suitable method known in the art, such as by a flat sheet process or a bubble or tubular process. The flat sheet process involves extruding or coextruding the materials of the sheet through a slit die and rapidly quenching the extruded or coextruded web upon a chilled casting drum so that the polymeric component(s) of the sheet are quenched below their solidification temperature.

The quenched sheet is then biaxially oriented by stretching in mutually perpendicular directions at a temperature above the glass transition temperature of the polymer(s). The sheet may be stretched in one direction and then in a second direction or may be simultaneously stretched in both directions. The preferred stretch ratio in any direction is at least 3:1. After the sheet has been stretched, it is heat set by heating to a temperature sufficient to crystallize the polymers while restraining to some degree the sheet against retraction in both directions of stretching.

The polymer sheet may be subjected to any number of coatings and treatments, after extrusion, coextrusion, orientation, etc. or between casting and full orientation, to improve its properties, such as printability, barrier properties, heat-sealability, spliceability, adhesion to other substrates and/or imaging layers. Examples of such coatings can be acrylic coatings for printability, polyvinylidene halide for heat seal properties, etc. Examples of such treatments can be flame, plasma and corona discharge treatment, ultraviolet radiation treatment, ozone treatment and electron beam treatment to improve coatability and adhesion. Further examples of treatments can be calendaring, embossing and patterning to obtain specific effects on the surface of the web. The polymer sheet can be further incorporated in any other suitable substrate by lamination, adhesion, cold or heat sealing, extrusion coating, or any other method known in the art.

The conductive layer of the invention can be formed by any method known in the art. Particularly preferred methods include coating from a suitable coating composition by any well known coating method such as air knife coating, gravure coating, hopper coating, roller coating, spray coating, electrochemical coating, inkjet printing, flexographic printing, and the like. Alternatively, the conductive layer can be transferred to a receiver member from a donor member by the application of heat and/or pressure. An adhesive layer may be preferably present between the conductive layer and the receiver member.

Another preferred method of forming the conductive layer is by thermal transfer as disclosed in a series of U.S. patents and patent applications, e.g., U.S. Pat. Nos. 6,114,088; 6,140,009; 6,214,520; 6,221,553; 6,582,876; 6,586,153 by Wolk et al.; U.S. Pat. Nos. 6,610,455; 6,582,875; 6,252,621; 2004/0029039 A1; by Tutt et al., U.S. Pat. No. 5,171,650 by Ellis et al.; 2004/0065970 A1 by Blanchet-Fincher. Accordingly, it is envisioned that a thermal transfer element comprising a donor substrate and a multicomponent transfer unit can be formed wherein the multicomponent transfer unit comprises the conductive layer of the invention. Such a transfer unit is fully or partially transferred through the application of heat onto a receiver substrate, thus incorporating the conductive layer of the invention on the receiver substrate.

Besides the conductive layer of the invention, the aforementioned thermal transfer element may comprise a number of other layers. These additional layers may include radiation absorption layer, which can be a light to heat conversion layer, interlayer, release layer, adhesion promoting layer, operational layer (which is used in the operation of a device), non-operational layer (which is not used in the operation of a device but can facilitate, for example, transfer of a transfer layer, protection from damage and/or contact with outside elements).

Thermal transfer of the layer of the invention can be accomplished by the application of directed heat on a selected portion of the thermal transfer element. Heat can be generated using a heating element (e.g., a resistive heating element), converting radiation (e.g., a beam of light) to heat, and/or applying an electrical current to a layer of thermal transfer element to generate heat.

For some specific display applications, such as those involving organic or polymeric light emitting diodes the roughness of the conductive layer can be critical. Typically, a very smooth surface, with low roughness (Ra) is desired for maximizing optical and barrier properties of the coated substrate. Preferred Ra values for the conductive layer of the invention is less than 1000 nm, more preferably less than 100 nm, and most preferably less than 20 nm. However, it is to be understood that if for some application a rougher surface is required higher Ra values can be attained within the scope of this invention, by any means known in the art.

A key criterion of the conductive layer of the invention involves two important characteristics of the conductive layer, namely its transparency and its surface electrical resistance. As alluded to herein above, the stringent requirement of high transparency and low SER demanded by modern display devices is extremely difficult to attain with electronically conductive polymers. Typically, lower surface electrical resistance values are obtained by coating relatively thick layers which undesirably reduces transparency. Additionally, even the same general class of conductive polymers, such as a polythiophene containing polymers, may result in different SER and transparency characteristics, based on differences in molecular weight, impurity content, doping level, morphology and the like.

In a particular embodiment of the invention the electronically conductive polymer layer may be formed into electrode or other array patterns. Useful patterning techniques include: inkjet printing, transfer printing such as lithoplate printing, various dry etching methods such as laser etching and thermal ablation, wet etching methods such as the microlithographic techniques described in WO97/18944 and U.S. Pat. No. 5,976,274, and others.

In one embodiment, the aforementioned substrate and the aforementioned electronically conductive polymer layer are incorporated as a transparent member in a display device. The display device typically comprises at least one imageable layer wherein the imageable layer can contain an electrically imageable material. The electrically imageable material can be light emitting or light modulating. Light emitting materials can be inorganic or organic in nature. Particularly preferred are organic light emitting diodes (OLED) or polymeric light emitting diodes (PLED). The light modulating material can be reflective or transmissive. Light modulating materials can be electrochemical, electrophoretic, such as Gyricon particles, electrochromic, or liquid crystals. The liquid crystalline material can be twisted nematic (TN), super-twisted nematic (STN), ferroelectric, magnetic, or chiral nematic liquid crystals. Especially preferred are chiral nematic liquid crystals. The chiral nematic liquid crystals can be polymer dispersed liquid crystals (PDLC). Structures having stacked imaging layers or multiple substrate layers, however, are optional for providing additional advantages in some case.

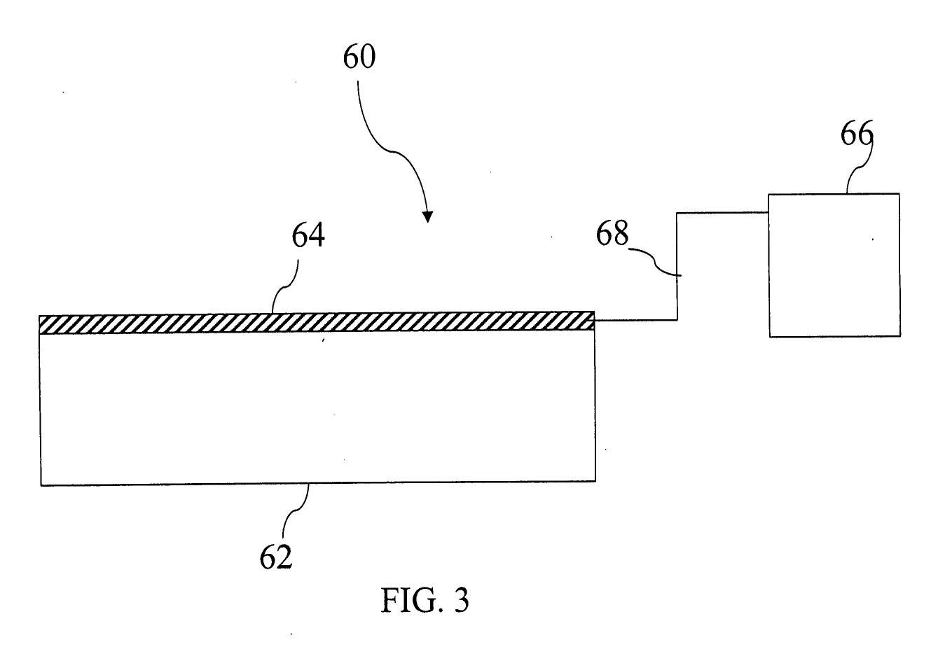

The present invention, comprising the aforementioned electronically conductive polymer layer and SWCNT may simply be substituted for any one or more conducting electrodes present in such prior art devices. The present invention preferably has at least one electric lead attached to (in contact with) the electronically conductive polymer layer on the substrate for the application of current, voltage, etc. to said conductive polymer (i.e. electrically connected). The lead(s) is/are preferably not in electrical contact with the substrate and may be made of patterned deposited metal, conductive or semiconductive material, such as ITO, may be a simple wire in contact with the conductive layer, and/or conductive paint comprising, for example, a conductive polymer, carbon, and/or metal particles. Devices according to the invention preferably also include a current or a voltage source electrically connected to the conducting electrode through the lead(s). A power source, battery, etc. may be used. One embodiment of the invention is illustrated in FIG. 3 as a display component 60, wherein a substrate 62 is coated with an electronically conductive polymer layer 64, which is connected to a power source 66 by means of an electric lead 68.

In a preferred embodiment, the electrically imageable material can be addressed with an electric field and then retain its image after the electric field is removed, a property typically referred to as “bistable”. Particularly suitable electrically imageable materials that exhibit “bistability” are electrochemical, electrophoretic, such as Gyricon particles, electrochromic, magnetic, or chiral nematic liquid crystals. Especially preferred are chiral nematic liquid crystals. The chiral nematic liquid crystals can be polymer dispersed liquid crystals (PDLC).

For purpose of illustration of the application of the present invention, the display will be described primarily as a liquid crystal display. However, it is envisioned that the present invention may find utility in a number of other display applications.

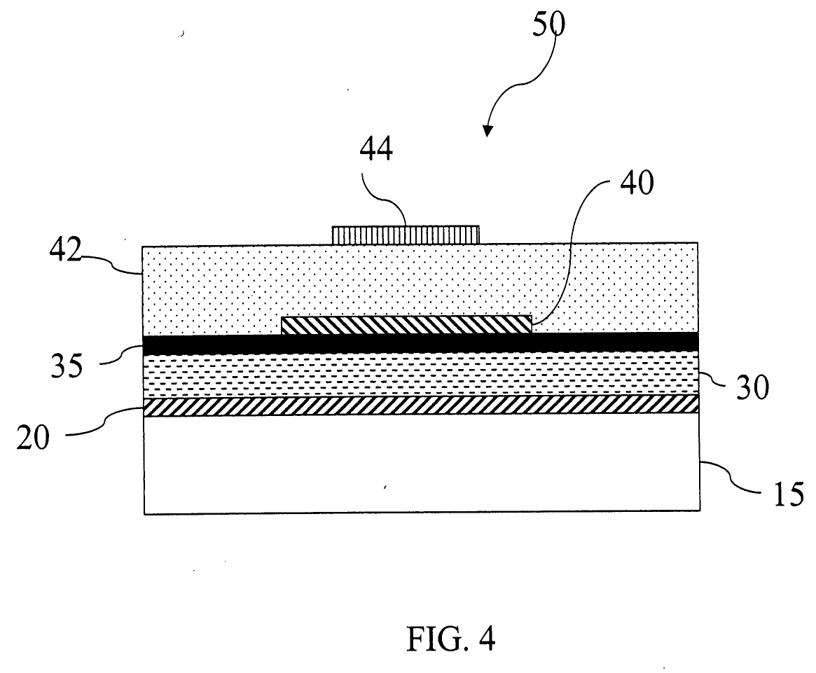

As used herein, a “liquid crystal display” (LCD) is a type of flat panel display used in various electronic devices. At a minimum, an LCD comprises a substrate, at least one conductive layer and a liquid crystal layer. LCDs may also comprise two sheets of polarizing material with a liquid crystal solution between the polarizing sheets. The sheets of polarizing material may comprise a substrate of glass or transparent plastic. The LCD may also include functional layers. In one embodiment of an LCD item 50, illustrated in FIG. 4, a transparent, multilayer flexible substrate 15 is coated with a first conductive layer 20, which may be patterned, onto which is coated the light-modulating liquid crystal layer 30. A second conductive layer 40 is applied and overcoated with a dielectric layer 42 to which dielectric conductive row contacts 44 are attached, including vias (not shown) that permit interconnection between conductive layers and the dielectric conductive row contacts. FIG. 4 shows an optional nanopigmented functional layer 35 applied between the liquid crystal layer 30 and the second conductive layer 40. In a typical matrix-address light-emitting display device, numerous light-emitting devices are formed on a single substrate and arranged in groups in a regular grid pattern. Activation may be by rows and columns.

The liquid crystal (LC) is used as an optical switch. The substrates are usually manufactured with transparent, conductive electrodes, in which electrical “driving” signals are coupled. The driving signals induce an electric field which can cause a phase change or state change in the LC material, the LC exhibiting different light-reflecting characteristics according to its phase and/or state.

LC

Liquid crystals can be nematic (N), chiral nematic (N*), or smectic, depending upon the arrangement of the molecules in the mesophase. Chiral nematic liquid crystal (N*LC) displays are typically reflective, that is, no backlight is needed, and can function without the use of polarizing films or a color filter.

Chiral nematic liquid crystal refers to the type of liquid crystal having finer pitch than that of twisted nematic and super-twisted nematic used in commonly encountered LC devices. Chiral nematic liquid crystals are so named because such liquid crystal formulations are commonly obtained by adding chiral agents to host nematic liquid crystals. Chiral nematic liquid crystals may be used to produce bi-stable or multi-stable displays. These devices have significantly reduced power consumption due to their non-volatile “memory” characteristic. Since such displays do not require a continuous driving circuit to maintain an image, they consume significantly reduced power. Chiral nematic displays are bistable in the absence of a field; the two stable textures are the reflective planar texture and the weakly scattering focal conic texture. In the planar texture, the helical axes of the chiral nematic liquid crystal molecules are substantially perpendicular to the substrate upon which the liquid crystal is disposed. In the focal conic state the helical axes of the liquid crystal molecules are generally randomly oriented. Adjusting the concentration of chiral dopants in the chiral nematic material modulates the pitch length of the mesophase and, thus, the wavelength of radiation reflected. Chiral nematic materials that reflect infrared radiation and ultraviolet have been used for purposes of scientific study. Commercial displays are most often fabricated from chiral nematic materials that reflect visible light. Some known LCD devices include chemically-etched, transparent, conductive layers overlying a glass substrate as disclosed in U.S. Pat. No. 5,667,853.

In one embodiment, a chiral-nematic liquid crystal composition may be dispersed in a continuous matrix. Such materials are referred to as “polymer-dispersed liquid crystal” materials or “PDLC” materials. Such materials can be made by a variety of methods. For example, Doane et al. (Applied Physics Letters, 48, 269 (1986)) disclose a PDLC comprising approximately 0.4 μm droplets of nematic liquid crystal 5CB in a polymer binder. A phase separation method is used for preparing the PDLC. A solution containing monomer and liquid crystal is filled in a display cell and the material is then polymerized. Upon polymerization the liquid crystal becomes immiscible and nucleates to form droplets. West et al. (Applied Physics Letters 63, 1471 (1993)) disclose a PDLC comprising a chiral nematic mixture in a polymer binder. Once again a phase separation method is used for preparing the PDLC. The liquid-crystal material and polymer (a hydroxy functionalized polymethylmethacrylate) along with a cross-linker for the polymer are dissolved in a common organic solvent toluene and coated on a transparent conductive layer on a substrate. A dispersion of the liquid-crystal material in the polymer binder is formed upon evaporation of toluene at high temperature. The phase separation methods of Doane et al. and West et al. require the use of organic solvents that may be objectionable in certain manufacturing environments.

The contrast of the display is degraded if there is more than a substantial monolayer of N*LC domains. The term “substantial monolayer” is defined by the Applicants to mean that, in a direction perpendicular to the plane of the display, there is no more than a single layer of domains sandwiched between the electrodes at most points of the display (or the imaging layer), preferably at 75 percent or more of the points (or area) of the display, most preferably at 90 percent or more of the points (or area) of the display. In other words, at most, only a minor portion (preferably less than 10 percent) of the points (or area) of the display has more than a single domain (two or more domains) between the electrodes in a direction perpendicular to the plane of the display, compared to the amount of points (or area) of the display at which there is only a single domain between the electrodes.

The amount of material needed for a monolayer can be accurately determined by calculation based on individual domain size, assuming a fully closed packed arrangement of domains. (In practice, there may be imperfections in which gaps occur and some unevenness due to overlapping droplets or domains.) On this basis, the calculated amount is preferably less than about 150 percent of the amount needed for monolayer domain coverage, preferably not more than about 125 percent of the amount needed for a monolayer domain coverage, more preferably not more than 110 percent of the amount needed for a monolayer of domains. Furthermore, improved viewing angle and broadband features may be obtained by appropriate choice of differently doped domains based on the geometry of the coated droplet and the Bragg reflection condition.

In a preferred embodiment of the invention, the display device or display sheet has simply a single imaging layer of liquid crystal material along a line perpendicular to the face of the display, preferably a single layer coated on a flexible substrate. Such as structure, as compared to vertically stacked imaging layers each between opposing substrates, is especially advantageous for monochrome shelf labels and the like. Structures having stacked imaging layers, however, are optional for providing additional advantages in some case.

Preferably, the domains are flattened spheres and have on average a thickness substantially less than their length, preferably at least 50% less. More preferably, the domains on average have a thickness (depth) to length ratio of 1:2 to 1:6. The flattening of the domains can be achieved by proper formulation and sufficiently rapid drying of the coating. The domains preferably have an average diameter of 2 to 30 microns. The imaging layer preferably has a thickness of 10 to 150 microns when first coated and 2 to 20 microns when dried.

The flattened domains of liquid crystal material can be defined as having a major axis and a minor axis. In a preferred embodiment of a display or display sheet, the major axis is larger in size than the cell (or imaging layer) thickness for a majority of the domains. Such a dimensional relationship is shown in U.S. Pat. No. 6,061,107.

Modern chiral nematic liquid crystal materials usually include at least one nematic host combined with a chiral dopant. In general, the nematic liquid crystal phase is composed of one or more mesogenic components combined to provide useful composite properties. Many such materials are available commercially. The nematic component of the chiral nematic liquid crystal mixture may be comprised of any suitable nematic liquid crystal mixture or composition having appropriate liquid crystal characteristics. Nematic liquid crystals suitable for use in the present invention are preferably composed of compounds of low molecular weight selected from nematic or nematogenic substances, for example from the known classes of the azoxybenzenes, benzylideneanilines, biphenyls, terphenyls, phenyl or cyclohexyl benzoates, phenyl or cyclohexyl esters of cyclohexanecarboxylic acid; phenyl or cyclohexyl esters of cyclohexylbenzoic acid; phenyl or cyclohexyl esters of cyclohexylcyclohexanecarboxylic acid; cyclohexylphenyl esters of benzoic acid, of cyclohexanecarboxyiic acid and of cyclohexylcyclohexanecarboxylic acid; phenyl cyclohexanes; cyclohexylbiphenyls; phenyl cyclohexylcyclohexanes; cyclohexylcyclohexanes; cyclohexylcyclohexenes; cyclohexylcyclohexylcyclohexenes; 1,4-bis-cyclohexylbenzenes; 4,4-bis-cyclohexylbiphenyls; phenyl- or cyclohexylpyrimidines; phenyl- or cyclohexylpyridines; phenyl- or cyclohexylpyridazines; phenyl- or cyclohexyldioxanes; phenyl- or cyclohexyl-1,3-dithianes; 1,2-diphenylethanes; 1,2-dicyclohexylethanes; 1-phenyl-2-cyclohexylethanes; 1-cyclohexyl-2-(4-phenylcyclohexyl)ethanes; 1-cyclohexyl-2′,2-biphenylethanes; 1-phenyl-2-cyclohexylphenylethanes; optionally halogenated stilbenes; benzyl phenyl ethers; tolanes; substituted cinnamic acids and esters; and further classes of nematic or nematogenic substances. The 1,4-phenylene groups in these compounds may also be laterally mono- or difluorinated. The liquid crystalline material of this preferred embodiment is based on the achiral compounds of this type. The most important compounds, that are possible as components of these liquid crystalline materials, can be characterized by the following formula R′—X—Y-Z-R″ wherein X and Z, which may be identical or different, are in each case, independently from one another, a bivalent radical from the group formed by -Phe-, -Cyc-, -Phe-Phe-, -Phe-Cyc-, -Cyc-Cyc-, -Pyr-, -Dio-, —B-Phe- and —B-Cyc-; wherein Phe is unsubstituted or fluorine-substituted 1,4-phenylene, Cyc is trans-1,4-cyclohexylene or 1,4-cyclohexenylene, Pyr is pyrimidine-2,5-diyl or pyridine-2,5-diyl, Dio is 1,3-dioxane-2,5-diyl, and B is 2-(trans-1,4-cyclohexyl)ethyl, pyrimidine-2,5-diyl, pyridine-2,5-diyl or 1,3-dioxane-2,5-diyl. Y in these compounds is selected from the following bivalent groups —CH═CH—, —C≡C—, —N═N(O)—, —CH═CY′—, —CH═N(O)—, —CH2-CH2-, —CO—O—, —CH2-O—, —CO—S—, —CH2-S—, —COO-Phe-COO— or a single bond, with Y′ being halogen, preferably chlorine, or —CN; R′ and R″ are, in each case, independently of one another, alkyl, alkenyl, alkoxy, alkenyloxy, alkanoyloxy, alkoxycarbonyl or alkoxycarbonyloxy with 1 to 18, preferably 1 to 12 C atoms, or alternatively one of R′ and R″ is —F, —CF3, —OCF3, —Cl, —NCS or —CN. In most of these compounds R′ and R′ are, in each case, independently of each another, alkyl, alkenyl or alkoxy with different chain length, wherein the sum of C atoms in nematic media generally is between 2 and 9, preferably between 2 and 7. The nematic liquid crystal phases typically consist of 2 to 20, preferably 2 to 15 components. The above list of materials is not intended to be exhaustive or limiting. The lists disclose a variety of representative materials suitable for use or mixtures, which comprise the active element in electro-optic liquid crystal compositions.

Suitable chiral nematic liquid crystal compositions preferably have a positive dielectric anisotropy and include chiral material in an amount effective to form focal conic and twisted planar textures. Chiral nematic liquid crystal materials are preferred because of their excellent reflective characteristics, bi-stability and gray scale memory. The chiral nematic liquid crystal is typically a mixture of nematic liquid crystal and chiral material in an amount sufficient to produce the desired pitch length. Suitable commercial nematic liquid crystals include, for example, E7, E44, E48, E31, E80, BL087, BL101, ZLI-3308, ZLI-3273, ZLI-5048-000, ZLI-5049-100, ZLI-5100-100, ZLI-5800-000, MLC-6041-100.TL202, TL203, TL204 and TL205 manufactured by E. Merck (Darmstadt, Germany). Although nematic liquid crystals having positive dielectric anisotropy, and especially cyanobiphenyls, are preferred, virtually any nematic liquid crystal known in the art, including those having negative dielectric anisotropy should be suitable for use in the invention. Other nematic materials may also be suitable for use in the present invention as would be appreciated by those skilled in the art.

Chiral Dopant

The chiral dopant added to the nematic mixture to induce the helical twisting of the mesophase, thereby allowing reflection of visible light, can be of any useful structural class. The choice of dopant depends upon several characteristics including among others its chemical compatibility with the nematic host, helical twisting power, temperature sensitivity, and light fastness. Many chiral dopant classes are known in the art: e.g., G. Gottarelli and G. Spada, Mol. Cryst. Liq. Crys., 123, 377 (1985); G. Spada and G. Proni, Enantiomer, 3, 301 (1998) and references therein. Typical well-known dopant classes include 1,1-binaphthol derivatives; isosorbide (D-1) and similar isomannide esters as disclosed in U.S. Pat. No. 6,217,792; TADDOL derivatives (D-2) as disclosed in U.S. Pat. No. 6,099,751; and the pending spiroindanes esters (D-3) as disclosed in U.S. patent application Ser. No. 10/651,692 by T. Welter et al., filed Aug. 29, 2003, titled “Chiral Compounds And Compositions Containing The Same,”.

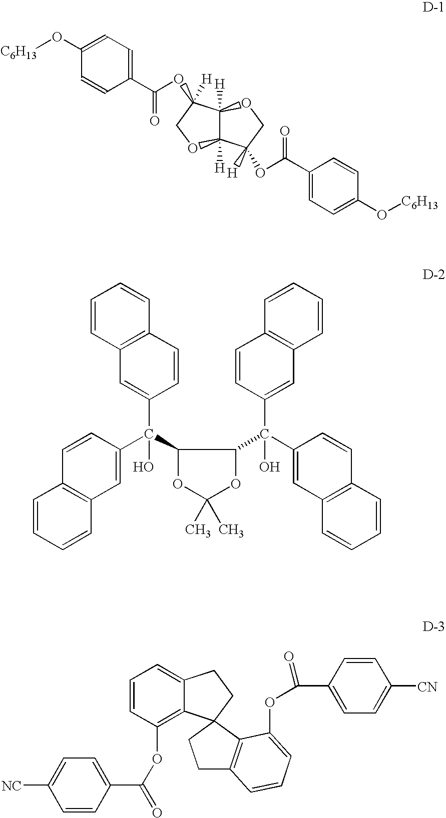

The pitch length of the liquid crystal materials may be adjusted based upon the following equation (1):
λmax=nav p0
where λmax is the peak reflection wavelength, that is, the wavelength at which reflectance is a maximum, nav is the average index of refraction of the liquid crystal material, and p0 is the natural pitch length of the chiral nematic helix. Definitions of chiral nematic helix and pitch length and methods of its measurement, are known to those skilled in the art such as can be found in the book, Blinov, L. M., Electro-optical and Magneto-Optical Properties of Liquid Crystals, John Wiley & Sons Ltd. 1983. The pitch length is modified by adjusting the concentration of the chiral material in the liquid crystal material. For most concentrations of chiral dopants, the pitch length induced by the dopant is inversely proportional to the concentration of the dopant. The proportionality constant is given by the following equation (2):
p0=1/(HTP.c)

where c is the concentration of the chiral dopant and HTP (as termed □ in some references) is the proportionality constant.

For some applications, it is desired to have LC mixtures that exhibit a strong helical twist and thereby a short pitch length. For example in liquid crystalline mixtures that are used in selectively reflecting chiral nematic displays, the pitch has to be selected such that the maximum of the wavelength reflected by the chiral nematic helix is in the range of visible light. Other possible applications are polymer films with a chiral liquid crystalline phase for optical elements, such as chiral nematic broadband polarizers, filter arrays, or chiral liquid crystalline retardation films. Among these are active and passive optical elements or color filters and liquid crystal displays, for example STN, TN, AMD-TN, temperature compensation, polymer free or polymer stabilized chiral nematic texture (PFCT, PSCT) displays. Possible display industry applications include ultralight, flexible, and inexpensive displays for notebook and desktop computers, instrument panels, video game machines, videophones, mobile phones, hand-held PCs, PDAs, e-books, camcorders, satellite navigation systems, store and supermarket pricing systems, highway signs, informational displays, smart cards, toys, and other electronic devices.

There are alternative display technologies to LCDs that may be used, for example, in flat panel displays. A notable example is organic or polymer light emitting devices (OLEDs) or (PLEDs), which are comprised of several layers in which one of the layers is comprised of an organic material that can be made to electroluminesce by applying a voltage across the device. An OLED device is typically a laminate formed in a substrate such as glass or a plastic polymer. Alternatively, a plurality of these OLED devices may be assembled such to form a solid state lighting display device.

A light emitting layer of a luminescent organic solid, as well as adjacent semiconductor layers, are sandwiched between an anode and a cathode. The semiconductor layers may be hole injecting and electron injecting layers. PLEDs may be considered a subspecies of OLEDs in which the luminescent organic material is a polymer. The light emitting layers may be selected from any of a multitude of light emitting organic solids, e.g., polymers that are suitably fluorescent or chemiluminescent organic compounds. Such compounds and polymers include metal ion salts of 8-hydroxyquinolate, trivalent metal quinolate complexes, trivalent metal bridged quinolate complexes, Schiff-based divalent metal complexes, tin (IV) metal complexes, metal acetylacetonate complexes, metal bidenate ligand complexes incorporating organic ligands, such as 2-picolylketones, 2-quinaldylketones, or 2-(o-phenoxy) pyridine ketones, bisphosphonates, divalent metal maleonitriledithiolate complexes, molecular charge transfer complexes, rare earth mixed chelates, (5-hydroxy) quinoxaline metal complexes, aluminum tris-quinolates, and polymers such as poly(p-phenylenevinylene), poly(dialkoxyphenylenevinylene), poly(thiophene), poly(fluorene), poly(phenylene), poly(phenylacetylene), poly(aniline), poly(3-alkylthiophene), poly(3-octylthiophene), and poly(N-vinylcarbazole). When a potential difference is applied across the cathode and anode, electrons from the electron injecting layer and holes from the hole injecting layer are injected into the light emitting layer; they recombine, emitting light. OLEDs and PLEDs are disclosed in the following United States patents: U.S. Pat. No. 5,707,745 to Forrest et al., U.S. Pat. No. 5,721,160 to Forrest et al., U.S. Pat. No. 5,757,026 to Forrest et al., U.S. Pat. No. 5,834,893 to Bulovic et al., U.S. Pat. No. 5,861,219 to Thompson et al., U.S. Pat. No. 5,904,916 to Tang et al., U.S. Pat. No. 5,986,401 to Thompson et al., U.S. Pat. No. 5,998,803 to Forrest et al., U.S. Pat. No. 6,013,538 to Burrows et al., U.S. Pat. No. 6,046,543 to Bulovic et al., U.S. Pat. No. 6,048,573 to Tang et al., U.S. Pat. No. 6,048,630 to Burrows et al., U.S. Pat. No. 6,066,357 to Tang et al., U.S. Pat. No. 6,125,226 to Forrest et al., U.S. Pat. No. 6,137,223 to Hung et al., U.S. Pat. No. 6,242,115 to Thompson et al., and U.S. Pat. No. 6,274,980 to Burrows et al.

In a typical matrix address light emitting display device, numerous light emitting devices are formed on a single substrate and arranged in groups in a regular grid pattern. Activation may be by rows and columns, or in an active matrix with individual cathode and anode paths. OLEDs are often manufactured by first depositing a transparent electrode on the substrate, and patterning the same into electrode portions. The organic layer(s) is then deposited over the transparent electrode. A metallic electrode may be formed over the organic layers. For example, disclosed in U.S. Pat. No. 5,703,436 to Forrest et al, transparent indium tin oxide (ITO) is used as the hole injecting electrode, and a Mg—Ag-ITO electrode layer is used for electron injection.

The present invention can be employed in most OLED device configurations as an electrode, preferably as an anode. These include very simple structures comprising a single anode and cathode to more complex devices, such as passive matrix displays comprised of orthogonal arrays of anodes and cathodes to form pixels, and active-matrix displays where each pixel is controlled independently, for example, with thin film transistors (TFTs).

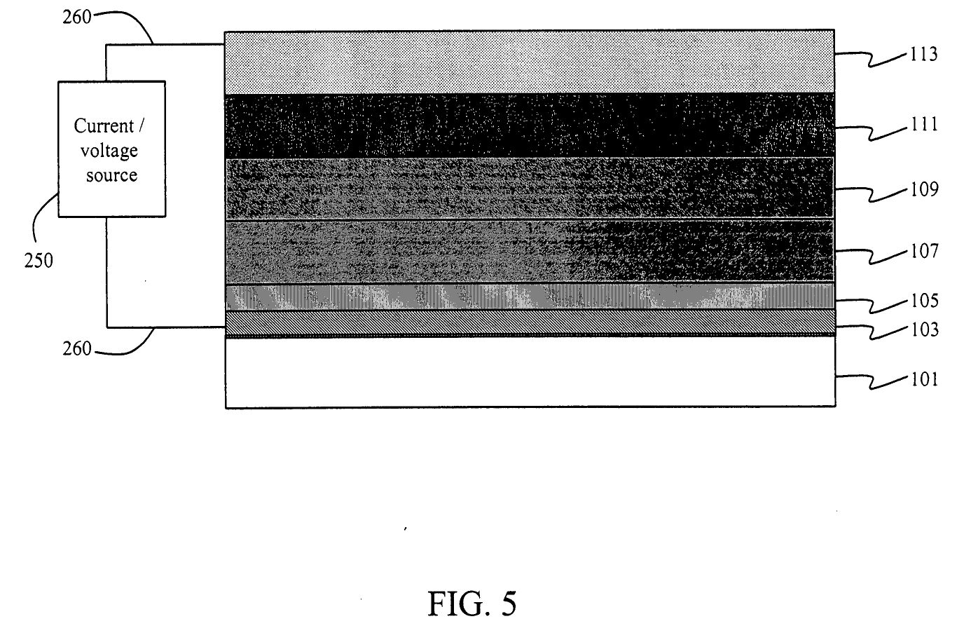

There are numerous configurations of the organic layers wherein the present invention can be successfully practiced. A typical structure is shown in FIG. 5 and is comprised of a substrate 101, an anode 103, a hole-injecting layer 105, a hole-transporting layer 107, a light-emitting layer 109, an electron-transporting layer 111, and a cathode 113. These layers are described in more detail below. Note that the substrate may alternatively be located adjacent to the cathode, or the substrate may actually constitute the anode or cathode. The organic layers between the anode and cathode are conveniently referred to as the organic electroluminescent (EL) element. The total combined thickness of the organic layers is preferably less than 500 nm.

The anode and cathode of the OLED are connected to a voltage/current source 250 through electrical conductors 260. The OLED is operated by applying a potential between the anode and cathode such that the anode is at a more positive potential than the cathode. Holes are injected into the organic EL element from the anode and electrons are injected into the organic EL element at the anode. Enhanced device stability can sometimes be achieved when the OLED is operated in an AC mode where, for some time period in the cycle, the potential bias is reversed and no current flows. An example of an AC driven OLED is described in U.S. Pat. No. 5,552,678.

When EL emission is viewed through anode 103, the anode should be transparent or substantially transparent to the emission of interest. Thus, the TRANSPARENCY of this invention is critical for such OLED display devices. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode. For applications where EL emission is viewed only through the cathode electrode, the transmissive characteristics of anode are generally immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes. Optionally, anodes may be polished prior to application of other layers to reduce surface roughness so as to minimize shorts or enhance reflectivity. It is hoped that the conductive film will have acceptable surface roughness as a result of the film forming capabilities of the conductive polymer, pedot.

Another application of the invention is envisioned for touch screens. Touch screens are widely used in conventional CRTs and in flat-panel display devices in computers and in particular with portable computers. The present invention can be applied as a transparent conductive member in any of the touch screens known in the art, including but not limited to those disclosed in U.S. Pat. Appl. Pub. 2003/0170456 A1; 2003/0170492 A1; U.S. Pat. No. 5,738,934; and WO 00/39835.

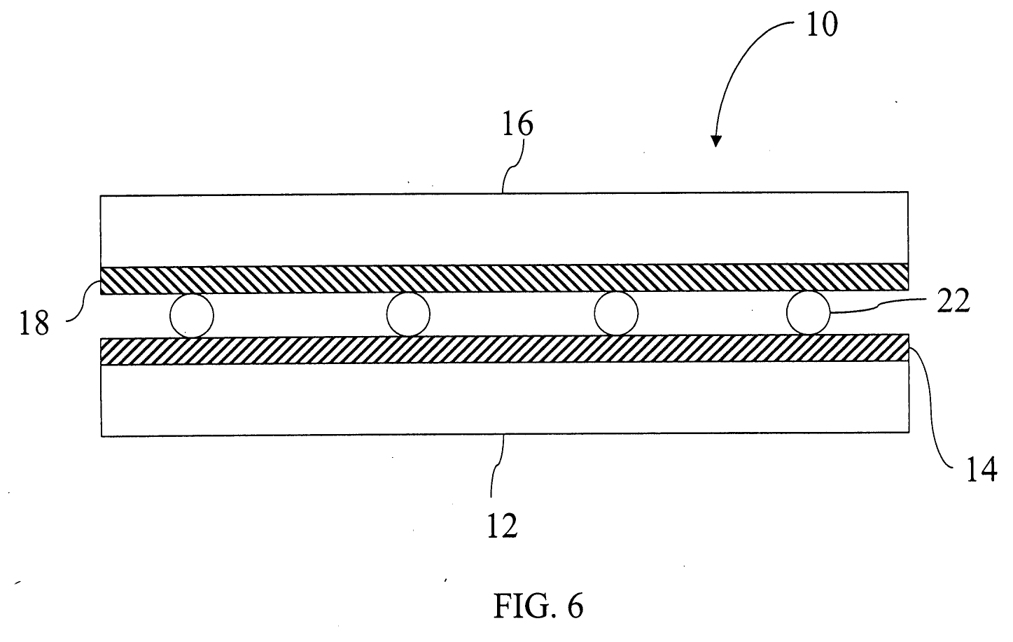

FIG. 6 shows a multilayered item 10 for a typical prior art resistive-type touch screen including a transparent substrate 12, having a first conductive layer 14. A flexible transparent cover sheet 16 includes a second conductive layer 18 that is physically separated from the first conductive layer 14 by spacer elements 22. A voltage is developed across the conductive layers. The conductive layers 14 and 18 have a resistance selected to optimize power usage and position sensing accuracy. Deformation of the flexible cover sheet 16 by an external object such as a finger or stylus causes the second conductive layer 18 to make electrical contact with first conductive layer 14, thereby transferring a voltage between the conductive layers. The magnitude of this voltage is measured through connectors (not shown) connected to metal conductive patterns (not shown) formed on the edges of conductive layers 18 and 14 to locate the position of the deforming object.

The conventional construction of a resistive touch screen involves the sequential placement of materials upon the substrate. The substrate 12 and cover sheet 16 are first cleaned, then uniform conductive layers are applied to the substrate and cover sheet. It is known to use a coatable electronically conductive polymer such as polythiophene or polyaniline to provide the flexible conductive layers. See for example WO 00/39835, which shows a light transmissive substrate having a light transmissive conductive polymer coating, and U.S. Pat. No. 5,738,934 which shows a cover sheet having a conductive polymer coating. The spacer elements 20 are then applied and, finally, the flexible cover sheet 16 is attached.

The invention has been described in detail with particular reference to certain preferred embodiments thereof, but it will be understood that variations and modifications can be effected within the spirit and scope of the invention.

### PARTS LIST

10 item for resistive-type touchscreen
12 transparent substrate
14 first conductive layer
15 flexible substrate
16 transparent cover sheet
18 second conductive layer
20 first conductive layer
22 spacer element
30 light-modulating liquid crystal layer
35 nanopigmented functional layer
40 second conductive layer
42 dielectric layer
44 conductive row contacts
50 LCD item
60 display component
62 substrate
64 electronically conductive polymer layer
66 power source
68 electric lead
101 substrate
103 anode
105 hole-injecting layer
107 hole-transporting layer
109 light-emitting layer
111 electron-transporting layer
113 cathode
250 voltage/current source
260 electrical conductors

1. A conductive film comprising single wall carbon nanotubes and polyethylenedioxythiophene.

2. The conductive film of claim 1 wherein said film has a transmission of at least 80% of visible light.

3. The conductive film of claim 1 wherein said film has surface resistivity up to 1,000 ohms/sq.

4. The conductive film of claim 1 wherein said film has a surface resistivity of between 0.001 and 500 ohms/sq.

5. The conductive film of claim 1 wherein said carbon nanotubes have a length of between 10 nanometers and 1 millimeter.

6. The conductive film of claim 1 wherein said carbon nanotubes have a diameter of between 0.5 and 4 nanometers.

7. The conductive film of claim 1 wherein said polyethylenedioxythiophene and the carbon nanotubes are in a weight ratio of between 1:99 and 99:1.

8. The conductive film of claim 1 further comprising a film forming binder.

9. The conductive film of claim 8
said film forming binder comprises a binder selected from the comprising water-soluble or water-dispersible hydrophilic polymers such as gelatin, gelatin derivatives, maleic acid or maleic anhydride copolymers, polystyrene sulfonates, cellulose derivatives (such as carboxymethyl cellulose, hydroxyethyl cellulose, cellulose acetate butyrate, diacetyl cellulose, and triacetyl cellulose), polyethylene oxide, polyvinyl alcohol, and poly-N-vinylpyrrolidone. Other suitable binders include aqueous emulsions of addition-type homopolymers and copolymers prepared from ethylenically unsaturated monomers such as acrylates including acrylic acid, methacrylates including methacrylic acid, acrylamides and methacrylamides, itaconic acid and its half-esters and diesters, styrenes including substituted styrenes, acrylonitrile and methacrylonitrile, vinyl acetates, vinyl ethers, vinyl and vinylidene halides, and olefins and aqueous dispersions of polyurethanes and polyesterionomers.

10. The conductive film of claim 1 further comprising a conductivity enhancer.

11. The conductive film of claim 10 wherein said conductivity enhancer comprises diethylene glycol.

12. The conductive film of claim 1 wherein said film has a thickness of between 10 nanometers and 100 micrometers.

13. The conductive film of claim 1 wherein said film has a thickness of between 10 nanometers and 1 micrometer.

14. The conductive film of claim 1 wherein said film is on a substrate.

15. The conductive film of claim 14 wherein said substrate comprises a flexible material.

16. The conductive film of claim 14 wherein said substrate comprises glass.

17. The conductive film of claim 14 further comprising a primer layer between said substrate and said conductive film.

18. The conductive film of claim 1 wherein said conductive film is in a pattern.

19. The conductive film of claim 1 wherein said polyethylenedioxythiophene has a figure of merit of less than or equal to 50.

20. The conductive film of claim 1 wherein said polyethylenedioxythiophene is in the cationic form.

21. The conductive film of claim 20 further comprising a polyanion.

22. A method of forming a conductive film comprising providing single wall carbon nanotubes, dispersing said carbon nanotubes in a liquid medium containing dispersant, laying down a layer of the liquid medium having single wall carbon nanotubes, removing said dispersant to form a layer of carbon nanotubes, impregnating said layer of carbon nanotubes with polyethylenedioxythiophene or a monomer for polyethylenedioxythiophene, and heating to cure the conductive film.

23. The method of claim 22 wherein said liquid medium comprises an aqueous medium.

24. The method of claim 22 wherein said impregnating is with a monomer for polyethylenedioxythiophene and an oxidant.

25. The method of claim 22 wherein said impregnating is with polyethylenedioxythiophene and a solvent for polyethylenedioxythiophene.

26. The method of claim 22 wherein said carbon nanotubes have a diameter of between 0.5 and 4 nanometers.

27. The method of claim 22 wherein said impregnating is with polyethylenedioxythiophene and a conductivity enhancer.

28. The method of claim 22 wherein said polyethylenedioxythiophene has a figure of merit of less than or equal to 50.

29. A method of forming a conductive film comprising mixing single wall carbon nanotubes and polyethylenedioxythiophene or a monomer for polyethylenedioxythiophene, forming a film of the mixture, and curing the film to form a conductive film.

30. The method of claim 29 wherein said mixing is carried out in an aqueous medium.

31. The method of claim 29 wherein said mixing further comprises an oxidant.

32. The method of claim 29 wherein said carbon nanotubes have a diameter of between 0.5 and 4 nanometers.

33. The method of claim 29 wherein said mixing further comprises a conductivity enhancer.

34. The method of claim 29 wherein said polyethylenedioxythiophene has a figure of merit of less than or equal to 50.

35. A display device, comprising a substrate, a conductive film on a surface of said substrate, and a lead electrically connected to said conductive film, wherein said conductive film comprises single wall carbon nanotubes and polyethylenedioxythiophene.

36. The device of claim 35 further comprising a current source electrically connected to said conductive film.

37. The device of claim 35, wherein a liquid crystalline material is in contact with said conductive film either directly or through a dielectric passivating layer.

38. The device of claim 35, further comprising a voltage source electrically connected to said conductive film.

39. The device of claim 35, wherein said conductive film forms a pattern on the surface of the substrate.

40. The device of claim 35, wherein said substrate is selected from the group consisting of polyethyleneterephthalate, polyethylenenaphthalate, polycarbonate, glass, and cellulose acetate.

41. The device of claim 35, wherein said substrate is flexible.

42. The display device of claim 35 further comprising at least one electrically imageable layer.

43. The display device of claim 42 wherein said electrically imageable material comprises light modulating material.

44. The display device of claim 43 wherein said light modulating material comprises at least one member selected from the group consisting of electrochemical, electrophoretic, electrochromic and liquid crystals.

45. The display device of claim 42 wherein said electrically imageable material comprises light emitting material.

46. The display device of claim 45 wherein said light emitting material comprises organic light emitting diodes or polymeric light emitting diodes.

47. The display device of claim 43 wherein said light modulating material is reflective or transmissive.

48. A method comprising providing a receiver, providing a donor member comprising a substrate and a transparent conductive film comprising single wall carbon nanotubes and polyethylenedioxythiophene, and transferring said transparent conductive film from said donor member to said receiver.

49. The method of claim 48 wherein heat is applied during transferring.

50. The method of claim 48 wherein pressure is applied during transferring.

51. The method of claim 48 wherein heat and pressure are applied during transfer.

52. The method of claim 48 wherein said receiver comprises an adhesive.

53. The method of claim 48 wherein transferring utilizes an adhesive between said conductive film and said receiver.
